(19) United States
(12) Patent Application Publication
(10) Pub. No.: US 2025/0113300 A1
(43) Pub. Date: Apr. 3, 2025

(54) METHOD AND APPARATUS FOR WAKE-UP SIGNAL TRANSMISSION BASED ON TIMING INFORMATION

(71) Applicant: MEDIATEK INC., Hsinchu City (TW)

(72) Inventors: Chien-Chun CHENG, Hsinchu City (TW); Wei-De WU, Hsinchu City (TW); Yi-Ju LIAO, Hsinchu City (TW); Cheng-Hsun LI, Hsinchu City (TW)

(21) Appl. No.: 18/726,313

(22) PCT Filed: Mar. 20, 2023
(86) PCT No.: PCT/CN2023/082603

§ 371 Date: Jul. 2, 2024

Related U.S. Application Data
(60) Provisional application No. 63/321,859, filed on Mar. 21, 2022.

(51) Int. Cl. H04W 52/02; H04W 74/0833

(52) U.S. Cl. CPC H04W 52/0216; H04W 52/0274; H04W 74/085

(57) ABSTRACT

Various solutions for wake-up signal (WUS) transmission based on timing information with respect to user equipment and network apparatus in mobile communications are described. An apparatus may receive a system information and a timing information for waking up a non-anchor cell from an anchor cell. The apparatus may transmit a WUS based on the system information and the timing information to wake up the non-anchor cell. The anchor cell comprises a cell where the apparatus is capable of receiving the system information and the timing information and performing a timing and frequency synchronization. The non-anchor cell comprises a cell where the apparatus cannot receive the system information and the timing information.

### CROSS REFERENCE TO RELATED PATENT APPLICATION(S)

The present disclosure claims the priority benefit of U.S. Provisional Patent Application No. 63/321,859, filed on 21 Mar. 2022. The content of aforementioned application is herein incorporated by reference in its entirety.

### TECHNICAL FIELD

The present disclosure is generally related to mobile communications and, more particularly, to wake-up signal (WUS) transmission based on timing information with respect to user equipment (UE) and network apparatus in mobile communications.

### BACKGROUND

Unless otherwise indicated herein, approaches described in this section are not prior art to the claims listed below and are not admitted as prior art by inclusion in this section.

The fifth-generation (5G) network, despite its enhanced energy efficiency in bits per Joule (e.g., 417% more efficiency than a 4G network) due to its larger bandwidth and better spatial multiplexing capabilities, may consume over 140% more energy than a 4G network.

For energy saving, 5G network may activate a sleep mode for a base station (BS) with low traffic loads. The sleep mode may turn off a power amplifier and other power-wasting components to save energy. When the traffic loads increase, network may deactivate the sleep mode for the base stations to balance the workload of neighboring base stations.

In order to deactivate the sleep mode, a signal used to wake up a base station is defined as a base station-wake-up signal (BS-WUS). The base station may receive the signal from the core 5G network or user equipments (UEs). However, it is unclear how the BS-WUS mechanism works in convention technologies.

Accordingly, how to transmit WUS becomes an important issue for the newly developed wireless communication network. Therefore, there is a need to provide proper schemes for WUS transmission for UE.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to transmit the wake-up signal (WUS) based on timing information with respect to user equipment and network apparatus in mobile communications.

In one aspect, a method may involve an apparatus receiving a system information and a timing information for waking up a non-anchor cell from an anchor cell. The method may also involve the apparatus transmitting a wake-up-signal (WUS) based on the system information and the timing information to wake up the non-anchor cell. The anchor cell comprises a cell where the apparatus is capable of receiving the system information and the timing information and performing a timing and frequency synchronization. The non-anchor cell comprises a cell where the apparatus cannot receive the system information and the timing information.

In one aspect, an apparatus may involve a transceiver which, during operation, wirelessly communicates with an anchor cell and a non-anchor cell of a wireless network. The apparatus may also involve a processor communicatively coupled to the transceiver such that, during operation, the processor performs following operations: receiving, via the transceiver, a system information and a timing information for waking up a non-anchor cell from an anchor cell; and transmitting, via the transceiver, a wake-up-signal (WUS) based on the system information and the timing information to wake up the non-anchor cell. The anchor cell comprises a cell where the apparatus is capable of receiving the system information and the timing information and performing a timing and frequency synchronization. The non-anchor cell comprises a cell where the apparatus cannot receive the system information and the timing information.

In one aspect, a method may involve an apparatus receiving a wake-up-signal (WUS) from a user equipment (UE). The method may also involve the apparatus waking up a second transceiver of the apparatus based on the WUS from the UE. The method may further involve the apparatus transiting from no or reduced transmission or reception activity to activate transmission or reception activity for a channel or a signal.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), Industrial Internet of Things (IIOT), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario of determining whether to sleep under schemes in accordance with implementations of the present disclosure.

FIG. 2 is a diagram depicting an example scenario of determining whether to wake up under schemes in accordance with implementations of the present disclosure.

FIG. 3 is a diagram depicting an example scenario of cellBarred indication under schemes in accordance with implementations of the present disclosure.

FIG. 4 is a diagram depicting an example scenario of timing information transmission under schemes in accordance with implementations of the present disclosure.

FIG. 5 is a diagram depicting an example scenario of pre-determined configuration for RA procedure under schemes in accordance with implementations of the present disclosure.

FIG. 6 is a diagram depicting an example scenario of BS-WUS transmission under schemes in accordance with implementations of the present disclosure.

FIG. 7 is a diagram depicting an example transceiver under schemes in accordance with implementations of the present disclosure.

FIG. 8 is a diagram depicting an example WUR transceiver under schemes in accordance with implementations of the present disclosure.

FIG. 9 is a diagram depicting an example WUS under schemes in accordance with implementations of the present disclosure.

FIG. 10 is a diagram depicting an example scenario of WUS transmission through WUR transceiver under schemes in accordance with implementations of the present disclosure.

FIG. 11 is a block diagram of an example communication system in accordance with an implementation of the present disclosure.

FIG. 12 is a flowchart of an example process in accordance with an implementation of the present disclosure.

FIG. 13 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to using on-demand reference signal for network energy saving with respect to user equipment and network apparatus in mobile communications. According to the present disclosure, a number of possible solutions may be implemented separately or jointly. That is, although these possible solutions may be described below separately, two or more of these possible solutions may be implemented in one combination or another.

The present disclosure proposes several schemes pertaining to WUS transmission based on timing information with respect to UE and network apparatus in mobile communications.

In accordance with implementations of the present disclosure, the “sleeping cell” or the “cell in sleeping mode” may be defined as the cell has no transmission activity or reception activity, or the cell has reduced transmission activity or reception activity. The sleeping cell may be waked up by the WUS signal. The WUS signal is used to request transmission from no or reduced transmission or reception activity to activate transmission or reception activity of a channel or a signal before the sleeping cell has been waked up. In addition, the WUS signal is used to trigger a synchronization signal (SS)/physical broadcast channel (PBCH) block (SSB) or system information block (SIB) transmission after the sleeping cell has been waked up.

Furthermore, in accordance with implementations of the present disclosure, the “non-anchor cell” may be defined as a sleeping cell without SIB or without SIB and SSB, i.e., the UE may not receive the SIB or not receive the SIB and SSB in the non-anchor cell. The “anchor cell” may be defined as a cell where the UE is capable of receiving SSB, system information and paging. In addition, in the present disclosure, the non-anchor cell may be associated with the anchor cell.

A network node may enter energy savings autonomously by monitoring the current traffic load, but the network node may be unclear to know whether it can leave the sleep mode autonomously without base station (BS)-WUS. Therefore, the present disclosure proposes some solutions to resolve the issues.

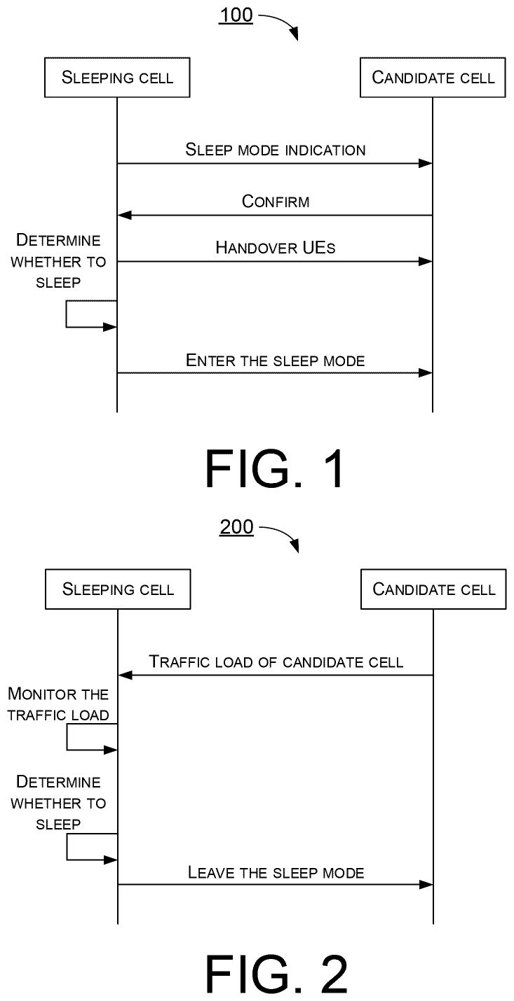

FIG. 1 illustrates an example scenario 100 of determining whether to sleep under schemes in accordance with implementations of the present disclosure. Scenario 100 involves a plurality of network nodes (e.g., a macro base station and multiple micro base stations) and a plurality of UEs, which may be a part of a wireless communication network (e.g., an LTE network, a 5G/NR network, an IoT network or a 6G network). Before a service provider (e.g., a network node) enters a sleep mode, the service provider may select candidate cells to maintain its coverage. The service provider may inform the candidate cell using a sleep mode indication (SMI). In addition, the service provider may offload its serving UEs to the candidate cells. The service provider may determine whether to enter the sleep mode based on whether the current served UEs have been transferred to the candidate cell. For example, for RRC_CONNECTED UEs, the service provider may use a handover (HO) message to move the RRC_CONNECTED UEs to the candidate cell. In another example, for RRC_IDLE UEs, the service provider may use cell reselection priority via the system information to transfer the RRC_IDLE UEs to camp on the candidate cell. Before the service provider enters the sleep mode, the service provider may need to finish transferring all served UEs to the candidate cell. In addition, the service provider may receive a threshold from the core network to determine how many RRC_CONNECTED UEs or how many RRC_IDLE UEs can be left the service, e.g., the number of UEs the service provider may not be able to transfer to the candidate cell before the service provider enters the sleep mode. When the service provider enters the sleep mode, the service provider may inform the candidate cell that the service provider has entered the sleeping mode.

FIG. 2 illustrates an example scenario 200 of determining whether to wake up under schemes in accordance with implementations of the present disclosure. Scenario 200 involves a plurality of network nodes (e.g., a macro base station and multiple micro base stations) and a plurality of UEs, which may be a part of a wireless communication network (e.g., an LTE network, a 5G/NR network, an IoT network or a 6G network). When the service provider has entered the sleep mode, the service provider (e.g., the network node in the sleeping cell) may monitor the traffic load of the candidate cell and decide to leave the sleeping mode when the service provider detects that additional capacity is needed. The sleeping cell may be waked up by the candidate cell using an indication. The candidate cell may provide a condition for the sleeping cell to wake up, e.g., the candidate cell's traffic load is beyond a threshold. The traffic load may be defined by the number of RRC_CONNECTED UEs or recourse utilization rates (RU). When the service provider is waked up, the service provider may inform the candidate cell that the service provider has left the sleeping mode (i.e., the service provider has left the energy-saving state).

When the UE cannot find a suitable cell, the UE may need to wake up any sleeping cell nearby. The legacy random access (RA) procedure may be reused to minimize spec impact, e.g., the legacy cell may not know the signaling based on new spec from the sleeping cell.

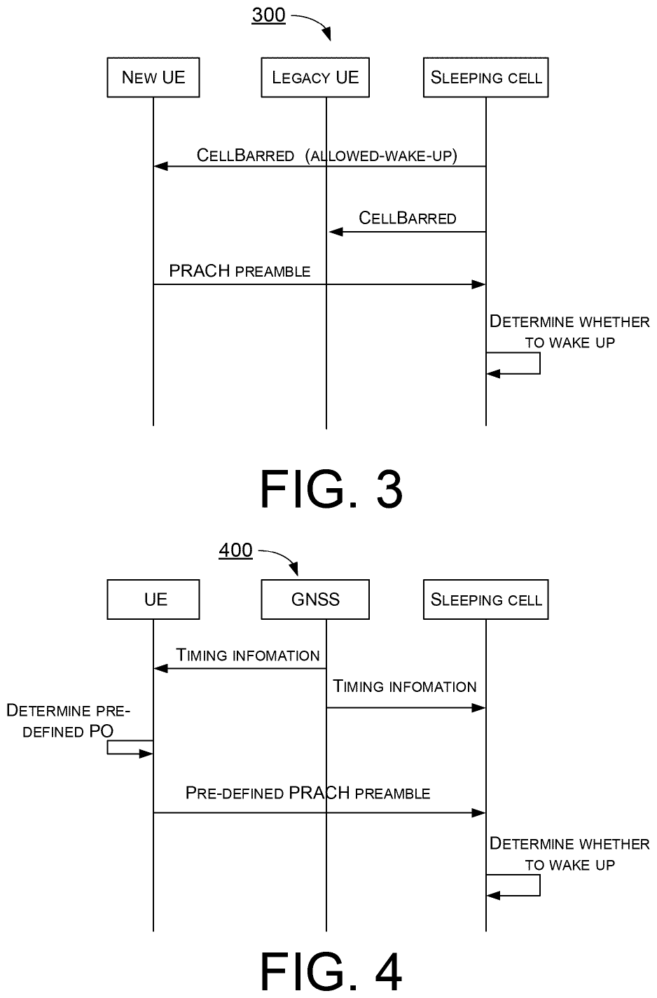

FIG. 3 illustrates an example scenario 300 of cellBarred indication under schemes in accordance with implementations of the present disclosure. Scenario 300 involves a plurality of network nodes (e.g., a macro base station and multiple micro base stations) and a plurality of UEs, which may be a part of a wireless communication network (e.g., an LTE network, a 5G/NR network, an IoT network or a 6G network). The sleeping cell may broadcast the cellBarred in MIB set to “barred” to prevent the legacy UE. If the UE is in RRC_IDLE or RRC_INACTIVE, or if UE is in RRC_CONNECTED while T311 timer is running, the UE may consider the cell as “barred”, and perform cell re-selection to other cells on the same frequency as the barred cell. Therefore, the legacy UE may not be allowed to camp on the sleeping cell.

A new cellBarred bit may be provided in MIB or SIB1 and denoted by allowed-wake-up. The cellBarred bit may be an always present bit as ENUMERATED {allowed, notAllowed}, or optionally present bit as ENUMERATED {allowed}. When the UE receives the allowed-wake-up field set to “allowed” in a cell, the UE may ignore cellBarred bit, and perform cell selection and random access on the cell, i.e., the new UE may allow to camp on the sleeping cell.

The sleeping cell may broadcast SSB and SIB1 for UE to transmit a BS-WUS using physical random access channel (PRACH) preamble. However, the broadcast may be an energy waste since there is not any data transmission in the broadcast. Therefore, the present disclosure proposes some solutions to resolve the issues.

FIG. 4 illustrates an example scenario 400 of timing information transmission under schemes in accordance with implementations of the present disclosure. Scenario 400 involves a plurality of network nodes (e.g., a macro base station and multiple micro base stations) and a plurality of UEs, which may be a part of a wireless communication network (e.g., an LTE network, a 5G/NR network, an IoT network or a 6G network). In addition, scenario 400 further involves a plurality of Global Navigation Satellite System (GNSS) satellites. The UE may try to wake up a sleeping cell if the UE is out of coverage. However, if the sleeping cell has no SSB transmission (i.e., the sleeping cell is a non-anchor cell), the sleeping cell cannot be a synchronization source. Therefore, the UE may select GNSS as the synchronization reference source to obtain timing information for timing synchronization. The UE may determine Direct Frame Number (DFN), e.g., the subframe number and the slot number from the current Coordinated Universal Time (UTC) of GNSS. In addition, the UE may determine a pre-defined PRACH occasion (PO) base on the timing information from the GNSS satellites and transmit a specific PRACH preamble on the pre-defined PRACH occasion.

DEN derivation from GNSS may include Tcurrent, Tref, OffsetDFN, and u. Tcurrent is the current UTC obtained from GNSS. The value of Tcurrent may be expressed in milliseconds. Tref is the reference UTC 00:00:00 on Gregorian calendar date 1 Jan. 1900 (midnight between Thursday, Dec. 31, 1899, and Friday, Jan. 1, 1900). The value of Tref may be expressed in milliseconds. OffsetDFN is the value of sl-OffsetDFN if configured. Otherwise, OffsetDFN is zero. The value of OffsetDFN may be expressed in milliseconds. μ=0/1/2/3 may correspond to the 15/30/60/120 kHz of subcarrier spacing (SCS).

In another example, the GNSS satellite may be replaced by a satellite that provides NR service or an NR cell. In this case, the NR satellite or the NR cell may provide the pre-defined random access (RA) resources and the synchronization timing.

The UE may select an SSB with synchronization signal (SS)-Reference Signal Received Power (RSRP) above rsrp-ThresholdSSB (or msgA-RSRP-ThresholdSSB) and sets the PREAMBLE_INDEX to a ra-PreambleIndex. However, if there is no SS-RSRP, the UE may not select the SSB, the preamble, and the random access (RA) types. In addition, since there is no SIB1, there is no configuration for the RA procedure. Therefore, the present disclosure proposes some solutions to resolve the issues.

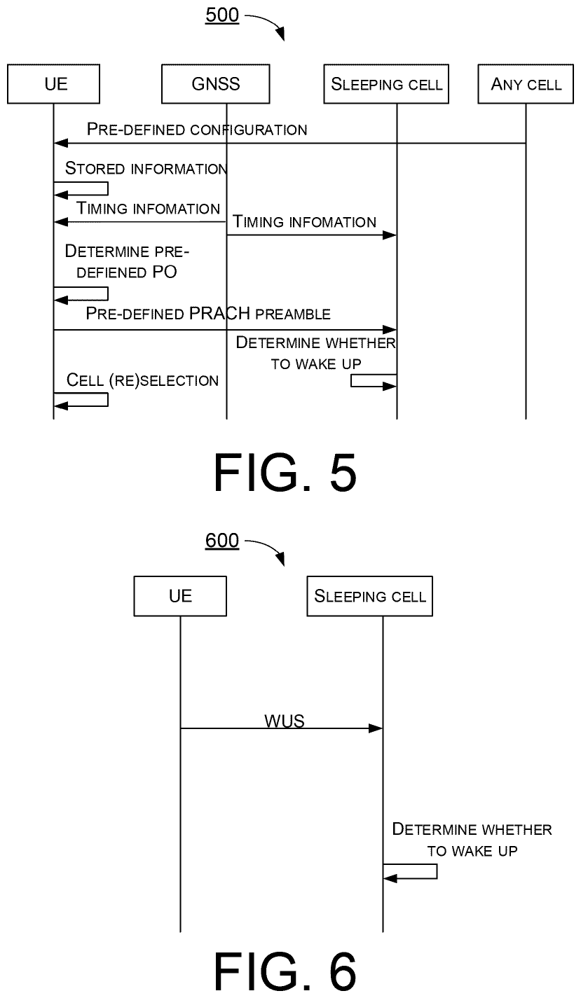

FIG. 5 illustrates an example scenario 500 of pre-determined configuration for RA procedure under schemes in accordance with implementations of the present disclosure. Scenario 500 involves a plurality of network nodes (e.g., a macro base station and multiple micro base stations) and a plurality of UEs, which may be a part of a wireless communication network (e.g., an LTE network, a 5G/NR network, an IoT network or a 6G network). In addition, scenario 500 further involves a plurality of GNSS satellites. A configuration for carrier information, PRACH transmission, a preamble index, a preamble SCS, and a PRACH resource may be pre-defined. After the UE transmits the pre-defined PRACH preamble to the sleeping cell, the UE may enter RRC_IDLE to perform cell (re) selection and suspend resending the pre-defined PRACH preamble for a period, e.g., 1 second.

The pre-defined configuration may be provided from any cell, including the sleeping cell if connected before. The pre-defined configuration may be provided via RRC signaling, e.g., RRCRelease message. The pre-defined configuration may be stored by the UE. The UE may use the stored information to transmit the pre-defined PRACH preamble to the sleeping cell when there is no cell to camp on, e.g., out of coverage.

The pre-defined configuration may be a subset of rach-ConfigDedicated. The information element (IE) rach-ConfigDedicated is used as the random access configuration for the reconfiguration with synchronization (e.g., handover). The UE may perform the RA according to the parameters in the firstActiveUplinkBWP of UplinkConfig.

For example, a compact configuration may be provided from any cell, including the sleeping cell. The compact configuration may have fields with 111 bits. These bits may be saved if a fixed configuration is specified. The fields may comprise following information elements (IEs).

The IE rach-ConfigGeneric is to specify the random-access parameters both for regular random access as well as for beam failure recovery.

The IE prach-ConfigurationIndex is the PRACH configuration index.

The IE msg1-FDM is for the number of PRACH transmission occasions frequency-division multiplexed (FDMed) in a one-time instance.

The IE msg1-Frequency Start is for offset of the lowest PRACH transmission occasion in the frequency domain concerning physical resource block (PRB) 0. The value is configured so that the corresponding RACH resource is entirely within the bandwidth of the UL Bandwidth Part (BWP).

The IE zeroCorrelationZoneConfig is the N-CS configuration.

The IE preambleReceivedTargetPower is the target power level at the network receiver side.

The IE preambleTransMax is the max number of RA preamble transmissions performed before declaring a failure.

The IE powerRampingStep is the power ramping steps for PRACH.

The IE ra-ResponseWindow is the Msg2 (RAR) window length in a number of slots. The network configures a value lower than or equal to 10 ms when Msg2 is transmitted in licensed spectrum and a value lower than or equal to 40 ms when Msg2 is transmitted with shared spectrum channel access.

The IE ssb-perRACH-Occasion is the number of SSBs per RACH occasion.

The IE ra-PreambleIndex is the preamble index that the UE shall use when performing CF-RA upon selecting the candidate beams identified by this SSB.

The IE ra-ssb-OccasionMaskIndex is the explicitly signaled PRACH Mask Index for RA Resource selection. The mask is valid for all SSB resources signaled in ssb-ResourceList.

The IE SubcarrierSpacing is the subcarrier spacing of this carrier. The IE SubcarrierSpacing is used to convert the offsetToCarrier into an actual frequency.

The IE locationAndBandwidth refers to this bandwidth part's frequency domain location and bandwidth. The first PRB is a PRB determined by subcarrierSpacing of this BWP and offsetToCarrier.

The IE offsetToCarrier is offset in the frequency domain between Point A (lowest subcarrier of common RB 0) and the lowest usable subcarrier on this carrier in the number of PRBs (using the subcarrierSpacing defined for this carrier).

The IE absoluteFrequencyPointA represents the frequency-location of point A expressed as in absolute radio-frequency channel number (ARFCN). Point A serves as a common reference point for resource block grids.

The IE ARFCN-ValueNR indicates the ARFCN applicable for a downlink, uplink, or bi-directional (TDD) NR global frequency raster.

Reusing PRACH preambles as BS-WUS may lead to interference for other cells. The UE in a normal cell may accidentally wake up a sleeping cell due to using a pre-defined PRACH preamble.

In addition, using a GNSS receiver in RRC_IDLE may significantly waste UE's power. Therefore, the present disclosure proposes some solutions to resolve the issues.

FIG. 6 illustrates an example scenario 600 of BS-WUS transmission under schemes in accordance with implementations of the present disclosure. Scenario 600 involves a plurality of network nodes (e.g., a macro base station and multiple micro base stations) and a plurality of UEs, which may be a part of a wireless communication network (e.g., an LTE network, a 5G/NR network, an IoT network or a 6G network). The UE may try to wake up a sleeping cell if the UE is out of coverage. The UE may transmit a BS-WUS sequence to the sleeping cell, e.g., Zadoff-Chu (ZC) sequence, generated based on a cell/base station group ID. The sleeping cell may use a wake-up radio (WUR) to detect the BS-WUS to determine whether to wake up.

However, it is unclear how to introduce WUR in NR. Therefore, the present disclosure proposes some solutions to resolve the issues.

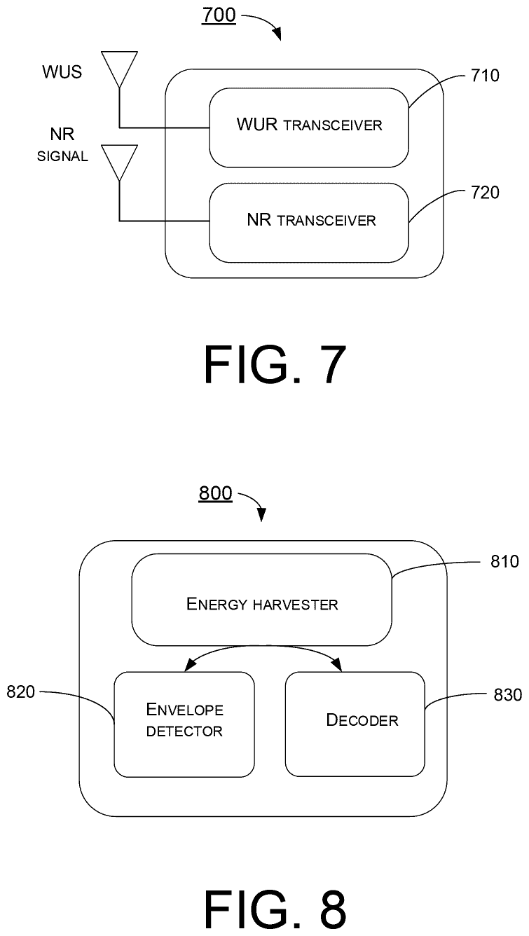

FIG. 7 illustrates an example transceiver 700 under schemes in accordance with implementations of the present disclosure. Transceiver 700 may be applied to a network node and a UE, which may be a part of a wireless communication network (e.g., an LTE network, a 5G/NR network, an IoT network or a 6G network). The network node and the UE may be equipped transceiver 700. WUR transceiver 710 of transceiver 700 may transmit and receive the wake-up signals, e.g., 2.4 Ghz, and NR transceiver 720 of transceiver 700 may transmit and receive normal signals. In addition, WUR transceiver 710 may be used to wake up the NR transceiver 720 when a wake-up signal is received, decoded successfully, and met a wake-up condition.

FIG. 8 illustrates an example WUR transceiver 800 under schemes in accordance with implementations of the present disclosure. WUR transceiver 800 may be applied to WUR transceiver 710. WUR transceiver 800 may at least comprise an energy harvester 810, an envelope detector 820 in front-end and a decoder 830 in back-end. Energy harvester 810 may use RF energy, magnetic, solar, wind, or vibrations.

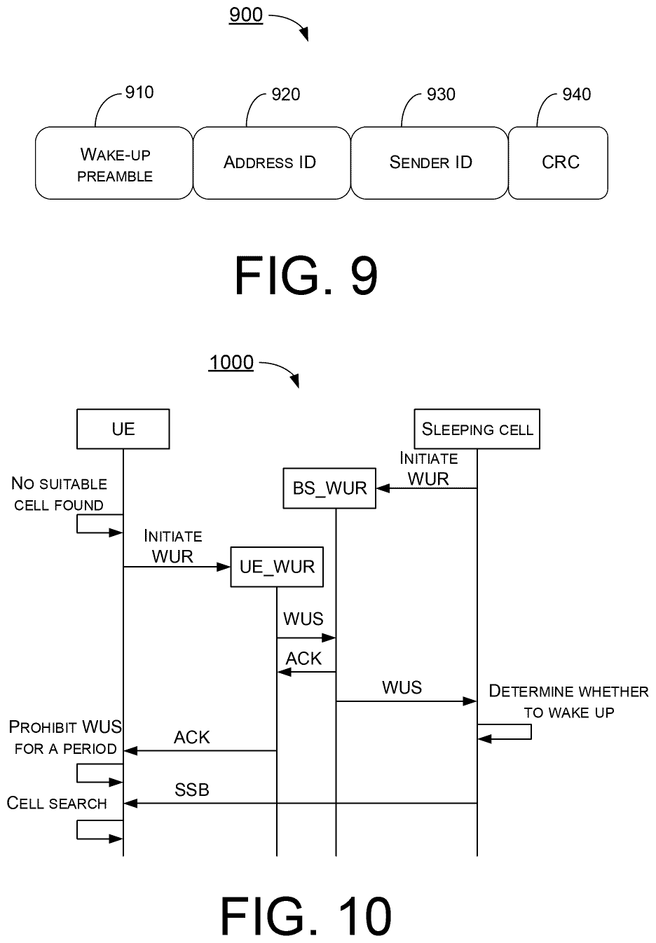

FIG. 9 illustrates an example WUS 900 under schemes in accordance with implementations of the present disclosure. As shown in FIG. 9, WUS 900 may consist of a wake-up preamble 910, address ID 920, sender ID 930, and cyclic redundancy check (CRC) 940.

The wake-up preamble 910 may use on-off keying (OOK) modulation and ZC sequence. OOK uses ‘1’s or ‘0’s, where an amplitude carrier is sent for ‘1’ and nothing is sent for ‘0’, i.e., the transmitter can be turned off. The receiver senses the rising edge of the digital signal from low to high via the RF front-end.

The address ID 920 and sender ID 930 may include cell ID and UE ID. The address ID 920 refers to a destination for the WUS, and the sender ID 930 refers to where the WUS is from. CRC 940 is used for error correction. Cell-Radio Network Temporary Identifier (C-RNTI) may scramble CRC to provide UE ID.

FIG. 10 illustrates an example scenario 1000 of WUS transmission through WUR transceiver under schemes in accordance with implementations of the present disclosure. Scenario 1000 involves a plurality of network nodes (e.g., a macro base station and multiple micro base stations) and a plurality of UEs, which may be a part of a wireless communication network (e.g., an LTE network, a 5G/NR network, an IoT network or a 6G network). A WUR transceiver (e.g., the UE_WUR of UE) may transmit a WUS to another WUR transceiver (e.g., the BS_WUR of sleeping cell). When a WUR transceiver (e.g., the BS_WUR of sleeping cell) has decoded a WUS successfully or has wake up an NR transceiver, the WUR transceiver may transmit an ACK to another WUR transceiver (e.g., the UE_WUR of UE) of the sender. The ACK signal is another WUS using the detected sender ID as the address ID and the WUR's ID as the sender ID. Once the WUR transceiver (e.g., the UE_WUR of UE) of the previous sender receives the ACK, the sender may stop transmitting any WUS (i.e., prohibit WUS transmission) for a period, e.g., 10 s. The sender's WUR transceiver may indicate the NR transceiver to perform the initial cell search to detect whether the sleeping cell has been woken up.

The UE may keep sending BS-WUS to fit the quality of service (QOS). However, it may lead to power consumption of the UE. Therefore, a prohibit timer may start when UE transmits a BS-WUS. When the prohibit timer runs, the UE may not be permitted to transmit another BS-WUS. The prohibit timer value may be provided in SIB.

The sleeping cell may bar the cell from protecting the legacy UE. However, it may prevent any chance to receive a BS-WUS. Therefore, the UE may receive a new field in MIB or SIB1 to indicate whether the cell can be woken up via BS-WUS. If the indication is present, the UE may transmit the BS-WUS to wake up the sleeping cell via a PRACH preamble or WUS, regardless of the cellBarred field. The configuration for the BS-WUS may be via SIB1 or other SIBs.

### Illustrative Implementations

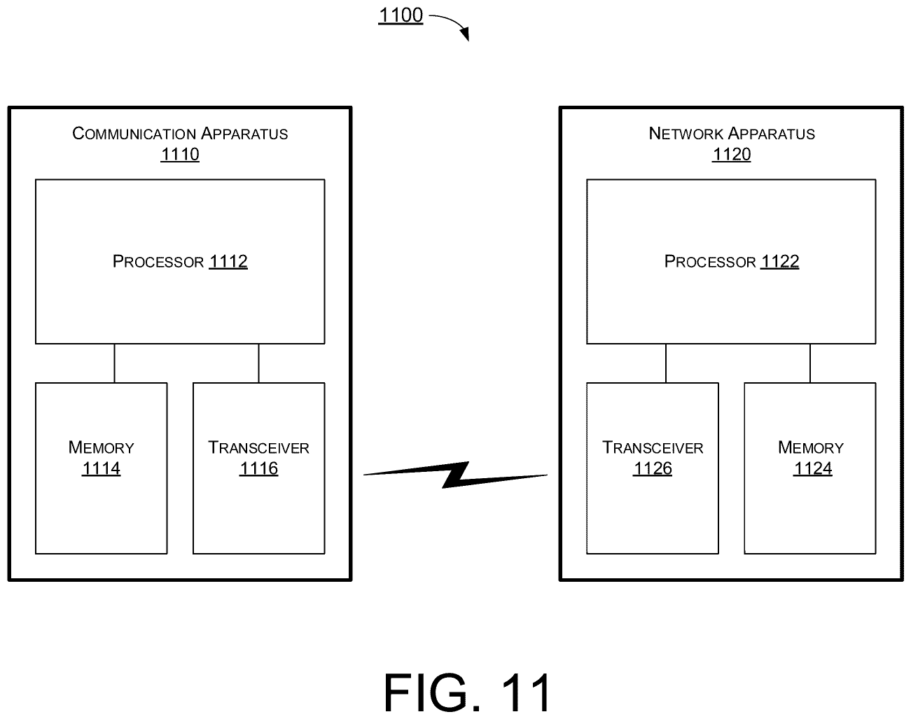

FIG. 11 illustrates an example communication system 1100 having an example communication apparatus 1110 and an example network apparatus 1120 in accordance with an implementation of the present disclosure. Each of communication apparatus 1110 and network apparatus 1120 may perform various functions to implement schemes, techniques, processes and methods described herein pertaining to WUS transmission based on timing information with respect to user equipment and network apparatus in mobile communications, including scenarios/schemes described above as well as processes 1200 and 1300 described below.

Communication apparatus 1110 may be a part of an electronic apparatus, which may be a UE such as a portable or mobile apparatus, a wearable apparatus, a wireless communication apparatus or a computing apparatus. For instance, communication apparatus 1110 may be implemented in a smartphone, a smartwatch, a personal digital assistant, a digital camera, or a computing equipment such as a tablet computer, a laptop computer or a notebook computer. Communication apparatus 1110 may also be a part of a machine type apparatus, which may be an IoT, NB-IoT, or IIOT apparatus such as an immobile or a stationary apparatus, a home apparatus, a wire communication apparatus or a computing apparatus. For instance, communication apparatus 1110 may be implemented in a smart thermostat, a smart fridge, a smart door lock, a wireless speaker or a home control center. Alternatively, communication apparatus 1110 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 1110 may include at least some of those components shown in FIG. 11 such as a processor 1112, for example. Communication apparatus 1110 may further include one or more other components not pertinent to the proposed scheme of the present disclosure (e.g., internal power supply, display device and/or user interface device), and, thus, such component(s) of communication apparatus 1110 are neither shown in FIG. 11 nor described below in the interest of simplicity and brevity.

Network apparatus 1120 may be a part of a network apparatus, which may be a network node such as a satellite, a base station, a small cell, a router or a gateway. For instance, network apparatus 1120 may be implemented in an eNodeB in an LTE network, in a gNB in a 5G/NR, IoT, NB-IoT or IIOT network or in a satellite or base station in a 6G network. Alternatively, network apparatus 1120 may be implemented in the form of one or more IC chips such as, for example and without limitation, one or more single-core processors, one or more multi-core processors, or one or more RISC or CISC processors. Network apparatus 1120 may include at least some of those components shown in FIG. 11 such as a processor 1122, for example. Network apparatus 1120 may further include one or more other components not pertinent to the proposed scheme of the present disclosure (e.g., internal power supply, display device and/or user interface device), and, thus, such component(s) of network apparatus 1120 are neither shown in FIG. 20 nor described below in the interest of simplicity and brevity.

In one aspect, each of processor 1112 and processor 1122 may be implemented in the form of one or more single-core processors, one or more multi-core processors, or one or more CISC processors. That is, even though a singular term “a processor” is used herein to refer to processor 1112 and processor 1122, each of processor 1112 and processor 1122 may include multiple processors in some implementations and a single processor in other implementations in accordance with the present disclosure. In another aspect, each of processor 1112 and processor 1122 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 1112 and processor 1122 is a special-purpose machine specifically designed, arranged and configured to perform specific tasks including autonomous reliability enhancements in a device (e.g., as represented by communication apparatus 1110) and a network (e.g., as represented by network apparatus 1120) in accordance with various implementations of the present disclosure.

In some implementations, communication apparatus 1110 may also include a transceiver 1116 coupled to processor 1112 and capable of wirelessly transmitting and receiving data. In some implementations, transceiver 1116 may comprise a WUR transceiver and a normal transceiver as transceiver 700. In some implementations, communication apparatus 1110 may further include a memory 1114 coupled to processor 1112 and capable of being accessed by processor 1112 and storing data therein. In some implementations, network apparatus 1120 may also include a transceiver 1126 coupled to processor 1122 and capable of wirelessly transmitting and receiving data. In some implementations, transceiver 1126 may comprise a WUR transceiver and a normal transceiver as transceiver 700. In some implementations, network apparatus 1120 may further include a memory 1124 coupled to processor 1122 and capable of being accessed by processor 1122 and storing data therein. Accordingly, communication apparatus 1110 and network apparatus 1120 may wirelessly communicate with each other via transceiver 1116 and transceiver 1126, respectively. To aid better understanding, the following description of the operations, functionalities and capabilities of each of communication apparatus 1110 and network apparatus 1120 is provided in the context of a mobile communication environment in which communication apparatus 1110 is implemented in or as a communication apparatus or a UE and network apparatus 1120 is implemented in or as a network node of a communication network.

In some implementations, processor 1112 may receive, via transceiver 1116, a system information and a timing information for waking up a non-anchor cell from an anchor cell. Processor 1112 may transmit, via transceiver 1116, a WUS based on the system information and the timing information to wake up the non-anchor cell. The anchor cell comprises a cell where communication apparatus 1110 is capable of receiving the system information and the timing information and performing a timing and frequency synchronization. The non-anchor cell comprises a cell where communication apparatus 1110 cannot receive the system information and the timing information.

In some implementations, processor 1112 may receive, via transceiver 1116, the timing information from at least one Global Navigation Satellite System (GNSS) satellite.

In some implementations, processor 1112 may perform a cell selection, a cell re-selection or a random access procedure with the non-anchor cell based on the system information and the timing information.

In some implementations, the system information comprises a configuration for at least one of carrier information, physical random access channel (PRACH) transmission, a preamble index, a preamble sub-carrier spacing (SCS) and a PRACH resource.

In some implementations, the WUS comprises a base station (BS)-WUS sequence, and wherein the WUS is used to request a transition from no or reduced transmission or reception activity to activate transmission or reception activity of a channel or a signal, or is used to trigger a synchronization signal block (SSB) or system information block (SIB) transmission.

In some implementations, processor 1112 may transmit the WUS through a wake-up transceiver of the transceiver 1116.

In some implementations, the WUS comprises at least one of a wake-up preamble, an address identification (ID), a sender ID and a sub-carrier spacing (SCS).

In some implementations, processor 1112 may start a prohibit timer in an event that the WUS is transmitted to the non-anchor cell. Processor 1112 may stop transmit another WUS when the prohibit timer is running.

In some implementations, processor 1112 may receive, via transceiver 1116, a master information block (MIB) or a system information block 1 (SIB1) to determine whether wake up the non-anchor cell.

In some implementations, processor 1122 may receive, via a first transceiver of transceiver 1126 a WUS from communication apparatus 1110. Processor 1122 may wake, via the first transceiver of transceiver 1126, a second transceiver of transceiver of transceiver 1126 up based on the WUS from the UE communication apparatus 1110. Processor 1122 may transit from no or reduced transmission or reception activity to activate transmission or reception activity for a channel or a signal.

In some implementations, the second transceiver of transceiver 1126 is in a power saving mode in an event that processor 1122 is in no or reduced transmission or reception activity

### Illustrative Processes

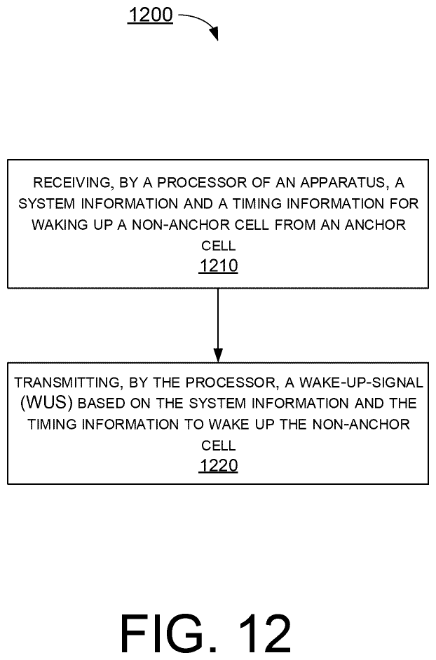

FIG. 12 illustrates an example process 1200 in accordance with an implementation of the present disclosure. Process 1200 may be an example implementation of above scenarios/schemes, whether partially or completely, with respect to WUS transmission based on timing information with the present disclosure. Process 1200 may represent an aspect of implementation of features of communication apparatus 1110. Process 1200 may include one or more operations, actions, or functions as illustrated by one or more of blocks 1210 and 1220. Although illustrated as discrete blocks, various blocks of process 1200 may be divided into additional blocks, combined into fewer blocks, or eliminated, depending on the desired implementation. Moreover, the blocks of process 1200 may be executed in the order shown in FIG. 12 or, alternatively, in a different order. Process 1200 may be implemented by communication apparatus 1110 or any suitable UE or machine type devices. Solely for illustrative purposes and without limitation, process 1200 is described below in the context of communication apparatus 1110. Process 1200 may begin at block 1210.

At 1210, process 1200 may involve processor 1112 of communication apparatus 1110 receiving a system information and a timing information for waking up a non-anchor cell from an anchor cell. The anchor cell comprises a cell where the apparatus is capable of receiving the system information and the timing information and performing a timing and frequency synchronization. The non-anchor cell comprises a cell where the apparatus cannot receive the system information and the timing information. Process 1200 may proceed from 1210 to 1220.

At 1220, process 1200 may involve processor 1112 transmitting a WUS based on the system information and the timing information to wake up the non-anchor cell.

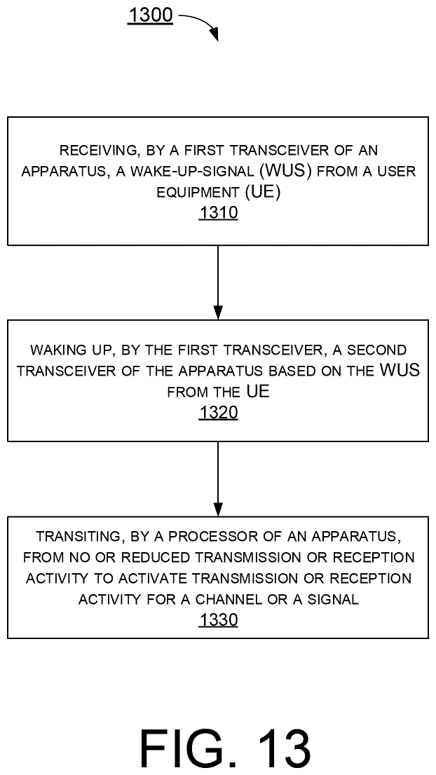

FIG. 13 illustrates an example process 1300 in accordance with an implementation of the present disclosure. Process 1300 may be an example implementation of above scenarios/schemes, whether partially or completely, with respect to WUS transmission based on timing information with the present disclosure. Process 1300 may represent an aspect of implementation of features of network apparatus 1120. Process 1300 may include one or more operations, actions, or functions as illustrated by one or more of blocks 1310, 1320 and 1330. Although illustrated as discrete blocks, various blocks of process 1300 may be divided into additional blocks, combined into fewer blocks, or eliminated, depending on the desired implementation. Moreover, the blocks of process 1300 may be executed in the order shown in FIG. 13 or, alternatively, in a different order. Process 1300 may be implemented by network apparatus 1320 or any base stations or network nodes. Solely for illustrative purposes and without limitation, process 1300 is described below in the context of network apparatus 1120. Process 1300 may begin at block 1310.

At 1310, process 1300 may involve a first transceiver of transceiver 1126 of network apparatus 1120 receiving a WUS from a UE. Process 1300 may proceed from 1310 to 1320.

At 1320, process 1300 may involve the first transceiver waking up a second transceiver of transceiver 1126 based on the WUS from the UE. Process 1300 may proceed from 1320 to 1330.

At 1330, process 1300 may involve processor 1122 of network apparatus 1120 transiting from no or reduced transmission or reception activity to activate transmission or reception activity for a channel or a signal.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving, by a processor of an apparatus, a system information and a timing information for waking up a non-anchor cell from an anchor cell; and
transmitting, by the processor, a wake-up-signal (WUS) based on the system information and the timing information to wake up the non-anchor cell,
wherein the anchor cell comprises a cell where the apparatus is capable of receiving the system information and the timing information and performing a timing and frequency synchronization,
wherein the non-anchor cell comprises a cell where the apparatus cannot receive the system information and the timing information.

2. The method of claim 1, wherein the receiving comprises receiving the timing information from at least one Global Navigation Satellite System (GNSS) satellite.

3. The method of claim 1, further comprising:
performing, by the processor, a cell selection, a cell re-selection or a random access procedure with the non-anchor cell based on the system information and the timing information.

4. The method of claim 1, wherein the system information comprises a configuration for at least one of carrier information, physical random access channel (PRACH) transmission, a preamble index, a preamble sub-carrier spacing (SCS) and a PRACH resource.

5. The method of claim 1, wherein the WUS comprises a base station (BS)-WUS sequence, and wherein the WUS is used to request a transition from no or reduced transmission or reception activity to activate transmission or reception activity of a channel or a signal, or is used to trigger a synchronization signal block (SSB) or system information block (SIB) transmission.

6. The method of claim 1, wherein the transmitting comprises transmitting the WUS through a wake-up transceiver of the apparatus.

7. The method of claim 6, wherein the WUS comprises at least one of a wake-up preamble, an address identification (ID), a sender ID and a sub-carrier spacing (SCS).

8. The method of claim 1, further comprising:
starting, by the processor, a prohibit timer in an event that the WUS is transmitted to the non-anchor cell; and
stopping, by the processor, transmitting another WUS when the prohibit timer is running.

9. The method of claim 1, further comprising:
receiving, by the processor, a master information block (MIB) or a system information block 1 (SIB1) to determine whether wake up the non-anchor cell.

10. An apparatus, comprising:
a transceiver which, during operation, wirelessly communicates with an anchor cell and a non-anchor cell of a wireless network; and
a processor communicatively coupled to the transceiver such that, during operation, the processor performs operations comprising:
receiving, via the transceiver, a system information and a timing information for waking up a non-anchor cell from an anchor cell; and
transmitting, via the transceiver, a wake-up-signal (WUS) based on the system information and the timing information to wake up the non-anchor cell,
wherein the anchor cell comprises a cell where the apparatus is capable of receiving the system information and the timing information and performing a timing and frequency synchronization,
wherein the non-anchor cell comprises a cell where the apparatus cannot receive the system information and the timing information.

11. The apparatus of claim 10, wherein, in receiving the system information and the timing information, the processor receives the timing information from at least one Global Navigation Satellite System (GNSS) satellite.

12. The apparatus of claim 10, wherein, during operation, the processor further performs operations comprising:
performing a cell selection, a cell re-selection or a random access procedure with the non-anchor cell based on the system information and the timing information.

13. The apparatus of claim 10, wherein the system information comprises a configuration for at least one of carrier information, physical random access channel (PRACH) transmission, a preamble index, a preamble sub-carrier spacing (SCS) and a PRACH resource.

14. The apparatus of claim 10, wherein the WUS comprises a base station (BS)-WUS sequence, and wherein the WUS is used to request a transition from no or reduced transmission or reception activity to activate transmission or reception activity of a channel or a signal, or is used to trigger a synchronization signal block (SSB) or system information block (SIB) transmission.

15. The apparatus of claim 10, wherein the transceiver comprise a wake-up transceiver, and wherein, in transmitting the WUS, the processor transmits the WUS through the wake-up transceiver.

16. The apparatus of claim 15, wherein the WUS comprises at least one of a wake-up preamble, an address identification (ID), a sender ID and a sub-carrier spacing (SCS).

17. The apparatus of claim 10, wherein, during operation, the processor further performs operations comprising:
starting a prohibit timer in an event that the WUS is transmitted to the non-anchor cell; and
stopping transmitting another WUS when the prohibit timer is running.

18. The apparatus of claim 10, wherein, during operation, the processor further performs operations comprising:
receiving, via the transceiver, a master information block (MIB) or a system information block 1 (SIB1) to determine whether wake up the non-anchor cell.

19. A method, comprising:
receiving, by a first transceiver of an apparatus, a wake-up-signal (WUS) from a user equipment (UE); and
waking up, by the first transceiver, a second transceiver of the apparatus based on the WUS from the UE; and
transiting, by a processor of an apparatus, from no or reduced transmission or reception activity to activate transmission or reception activity for a channel or a signal.

20. The method of claim 19, wherein the second transceiver is in a power saving mode in an event that the processor is in no or reduced transmission or reception activity.
